(19) United States
(12) Patent Application Publication
(10) Pub. No.: US 2014/0036312 A1
(43) Pub. Date: Feb. 6, 2014

(54) Photofinisher Status Notification System and Method

(71) Applicant: FUJIFILM North America Corporation, Valhalla, NY (US)

(72) Inventor: Steve Haak, Rochester, NY (US)

(73) Assignee: FUJIFILM North America Corporation, Valhalla, NY (US)

(21) Appl. No.: 13/959,283

(22) Filed: Aug. 5, 2013

Related U.S. Application Data
(60) Provisional application No. 61/679,689, filed on Aug. 4, 2012.

(51) Int. Cl. G06F 3/12

(52) U.S. Cl. CPC G06F 3/1294
USPC 358/1.15

(57) ABSTRACT

A system and method for providing notification of a change in status of a photofinisher is provided. The method includes the steps of providing a photofinisher configured for producing a print product incorporating a digital image, the print product being specified in a print order; receiving the print order to be produced by the photofinisher; detecting a change in status of the photofinisher; and sending a notification to at least one remote computing device, wherein the notification sent to the at least one remote computing device includes information related to the change in status of the photofinisher. A method for classifying the change in status and directing the notification to a selected group of remote computing devices is also provided.

### CROSS-REFERENCE TO RELATED APPLICATIONS

This application claims the benefit of U.S. Patent Application No. 61/679,689, filed Aug. 4, 2012, which is hereby incorporated by reference in its entirety.

### FIELD OF THE INVENTION

The present invention is directed to a photofinisher status notification system and method; in particular, the system and method is directed to notifying one or more remote computing devices regarding a change in status of one or more photofinishers. The system and method may also include selectively directing a notification to one or more of the remote computing devices based upon a classification of the change in status of the one or more photofinishers.

### BACKGROUND OF THE INVENTION

With the growing popularity of mobile computing devices and digital cameras capable of taking high resolution digital images, there is a growing demand for producing print products incorporating digital images, such as, photographic prints, calendars, mugs, and t-shirts. Print products are typically ordered by placing a print order using an online print product ordering website, or a self-service digital photograph processing station, such as a kiosk, which may be located within a store. The print order is fulfilled by a photofinisher, and the completed print product is then made available for pick up at a selected location or delivered to a designated recipient.

Depending upon the volume of print orders received, and the variety of print products that are made available to a consumer, it may be necessary to have a plurality of photofinishers available to fulfill the print orders in a timely manner. The photofinishers are typically located either on-site at mass retail store or drug stores for photographic prints, or located off-site for non-photographic print products, such as blankets, mugs, and t-shirts. The operation and oversight of the photofinishers are conducted by one or more individuals, such as a store employee, that has the duty to make sure that the photofinishers are operating properly and that print orders are fulfilled in an appropriate time frame. As print orders are being fulfilled, it is common for issues to arise with the photofinishers that require the employees to take some type of action. For instance, it is common for a photofinisher to run out of paper requiring an employee to refill a paper tray. Other issues that commonly occur include the photofinisher running out of ink, paper jams, and mechanical failure of the photofinisher. These types of occurrences, if not remedied within an appropriate time frame, will cause a delay in fulfilling print orders, and potentially create a print order back-up placing stress on the system.

When an issue arises with a photofinisher, it is common for a blinking light and/or text readout to display on the photofinisher to inform the store employee of the issue. Therefore, the store employee must be in close physical proximity to the photofinisher so that he or she can visually monitor them to ensure that they are running efficiently and to attend to issues that may arise with them. One problem with this system arises when the store employee responsible for monitoring the photofinishers needs to attend to duties in other locations of the store, and is not able to continuously visually monitor the photofinishers. This lack of attention given to the photofinishers results in increased delays in attending to issues that cause the photofinishers to stop fulfilling print orders, which in turn results in longer fulfillment times for print orders. This creates customer dissatisfaction when print orders are not fulfilled within the time parameters specified in a print order.

What is needed is a system and method for efficiently addressing issues that arise with a photofinisher to reduce the amount of time that the photofinisher is non-operational so that print orders can be fulfilled in a timely manner. The present invention fulfills these needs, as well as other needs.

### SUMMARY OF THE INVENTION

In order to overcome the above stated inefficiencies, one aspect of the present invention provides a method for providing notification of a change in status of a photofinisher. The method comprises providing a photofinisher configured for producing a print product incorporating a digital image, wherein the print product is specified in a print order. The method also includes the steps of receiving the print order to be produced by the photofinisher, detecting a change in status of the photofinisher, and sending a notification to at least one remote computing device regarding the change in status. The remote computing device may include, but is not limited to, a mobile computing device, a smart phone, tablet, laser/optical scan device, laptop, and desktop computer. Situations that result in the change in status of the photofinisher include, but are not limited to, when the photofinisher needs to be loaded with additional paper, paper in the photofinisher needs to be changed to a different size, a mechanical or electrical malfunction has occurred with the photofinisher, ink in the photofinisher is below a predetermined threshold, or the photofinisher is jammed with paper. The notification sent to the at least one remote computing device may be in the form of electronic mail, Short Message Service (SMS) text message, Multimedia Messaging Service (MMS) text message, push notification, application communication, or automated voice message, and includes information related to the change in status of the photofinisher. The information related to the change in status of the photofinisher may include at least one of identifying information of the photofinisher with the change in status, information describing the changed status of the photofinisher, an urgency level, or at least one of text, audio, or video to assist with correcting the issue that caused the change in status of the photofinisher to place the photofinisher in an operational state.

In another aspect, the method may further include the step of classifying the detected change in status of the photofinisher depending on the nature of the issue that caused in the change in status. After the change in status is classified, the notification may be selectively sent to one or more certain remote computing devices based on the classification.

In another aspect, the method may include sending the notification to one or more remote computing devices based upon their geographic proximity to the photofinisher with the change in status. For example, the notification may be sent to all remote computing devices located within a certain distance of the photofinisher, and not send the notification to those remote computing devices located outside a geographic area relative to the photofinisher unless the issue is not resolved by those individuals receiving the notice within the specified geographic area. In another example, the notification may be sent to the remote computing device located in the closest geographic proximity to the photofinisher.

The method may also include a step of receiving confirmation from the remote computing devices indicating that the notification was received. In this aspect, if a confirmation receipt of the notification is not received within a predetermined time period, the method includes resending the notification of the change in status to the at least one remote computing device. Further, with respect to the classification embodiment set forth above, if a confirmation receipt for the notification is not received within a predetermined time period from the first group that the notification was sent to, then the method further comprises sending the notification to a second group of remote computing devices. After receiving the notification, the method may allow the notification to be dismissed either manually, or automatically after a predetermined period of time, after which the notification may be sent another one of the remote computing devices.

In another aspect, a photofinisher status notification system is provided. The system includes a photofinisher configured for receiving a print order specifying a print product to be fulfilled, wherein the print product incorporates a digital image, wherein the photofinisher is configured for producing the print product. In addition, a photo lab system is in communication with the photofinisher, wherein the lab system is configured for recognizing a change in status of the photofinisher. Further, at least one remote computing device in communication with the photo lab system over a network, wherein the photo lab system is configured for sending a notification to the at least one remote computing device including information related to the change in status of the photofinisher.

The system may further include a notification server that is in communication with the photo lab system, and configured for sending the notification to the at least one remote computing device on behalf of the photo lab system. Also, the system may include a print product ordering server configured for receiving the print order, and sending the print order to the photofinisher, wherein the print product ordering server is configured for hosting a print product ordering website. Alternatively, or in addition to the print product ordering website, the system may include a kiosk configured for receiving the print order and sending the print order to the photofinisher.

Additional benefits of the above-described system and method for providing notification of a change in status of a photofinisher are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIG. 1 is a schematic diagram of an exemplary system according to one aspect of the present invention showing, among other things, one or more remote computing devices in communication with a photo lab system and a plurality of photofinishers through a network;

FIG. 2 is a flow diagram showing a method for providing notification of a change in status of a photofinisher according to one aspect of the present invention;

FIG. 3 is a flow diagram showing a method for providing notification of a change in status of a photofinisher according to another aspect of the present invention; and

FIG. 4 is a block diagram generally illustrating a computing environment in which the invention may be implemented.

### DETAILED DESCRIPTION OF THE INVENTION

Generally, the tools, systems, and methods described herein for providing notification of a change in status of a photofinisher to one or more remote computing devices may be implemented in hardware, software or a combination thereof. The notification of a change in status is sent to the one or more remote computing devices so that the issue that caused the change in status can be addressed in an efficient manner to enable the photofinisher to fulfill print orders in a timely manner without having to continuously, manually monitor the photofinisher. Other advantages may also be realized in view of the discussion that follows.

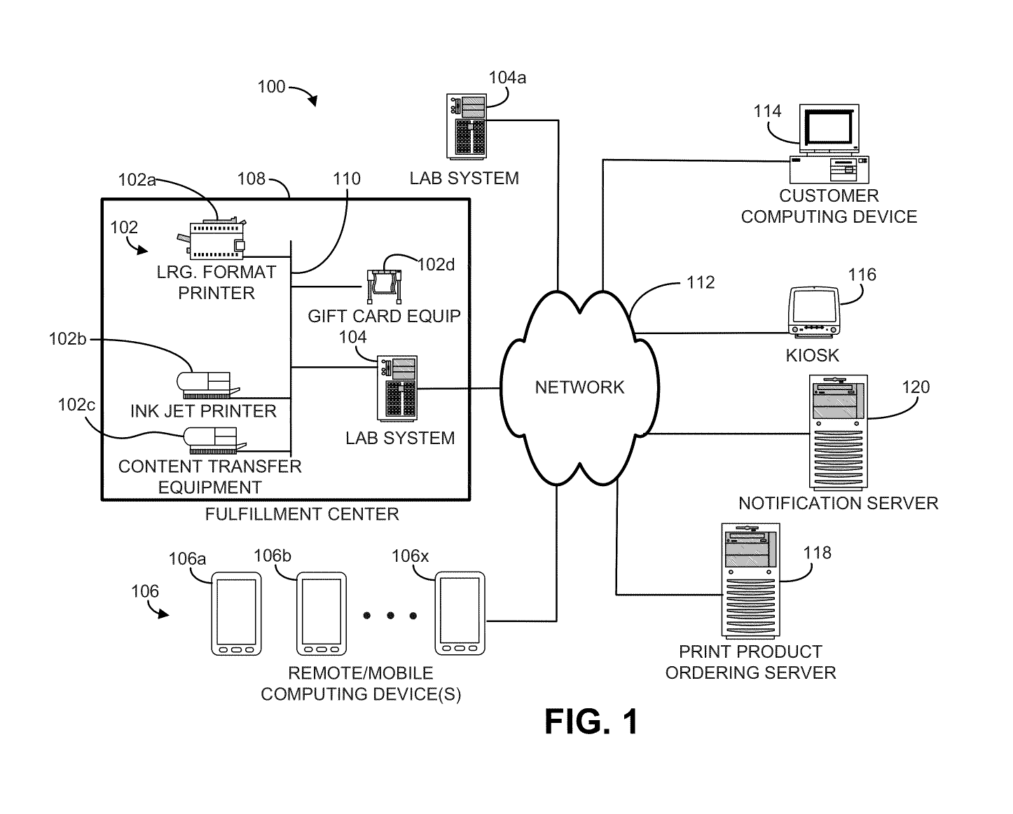

As best seen in FIG. 1, a photofinisher status notification system 100 in accordance with one aspect of the present invention may generally include one or more photofinishers 102, a photo lab system 104, and at least one remote computing device 106. The photofinishers 102 and photo lab system 104 may be located in a single location, such as a fulfillment center 108, and be in communication with each other using a local network connection 110. Fulfillment center 108 may be located within, for example, a mass retail store or a drug store. Instead of or in addition to using local photo lab system 104, it is also contemplated that a photo lab system 104a may be located remotely and be in communication with photofinishers 102 through a wide area network (WAN) 112, such as the Internet. It should be understood that any reference to photo lab system 104 set forth herein may also apply to photo lab system 104a. Further, the remote computing device 106 is in communication with photo lab system 104 and/or photofinishers 102 through network 112.

Each of the photofinishers 102 is a printing device that is configured for producing a print product that incorporates a digital image. The types of print products that may be produced by photofinishers 102 include, but are not limited to, photographic prints, calendars, posters, photo books, mugs, t-shirts, gift cards, and canvas prints. Given the wide variety of print products that may be produced, system 100 may include a plurality of different types of photofinishers 102a, 102b, 102c, 102d capable of producing the print products. The print products are typically ordered by a customer using either a customer computing device 114 or a kiosk 116. Using customer computing device 114 or kiosk 116, a customer may access a print product ordering server 118 that hosts a print product ordering website through network 112. Using the print product ordering website, the customer may upload one or more digital images, select a print product that incorporates the digital image, specify print characteristics of the selected print product (such as size and color parameters), edit the digital image, and then submit a print order to print product ordering server 118. The print order is then sent to photo lab system 104 or directly to an appropriate photofinisher 102 so that the print product can be produced and made available to a designated recipient.

Photo lab system 104 is in communication with each of photofinishers 102, and includes a photofinisher status module configured for detecting and/or recognizing when a change in status of one or more of photofinishers 102 occurs. There may be a number of reasons that cause a change in status of any of the photofinishers 102, but generally, a change in status may occur with a photofinisher when an issue arises that has, or may eventually have, an effect on that photofinisher's efficiency or ability to produce a print product that has been ordered by a customer. For example, a change in status from operational to non-operational may occur when photofinisher 102b runs out of the paper necessary to complete an ordered print product and photofinisher 102b needs to be loaded with additional paper. Other instances in which a change in status of a photofinisher may occur is when paper in the photofinisher needs to be changed to a different size, a mechanical or electrical malfunction has occurred with the photofinisher, ink in the photofinisher is below a predetermined threshold, or the photofinisher is jammed with paper. In addition to detecting or recognizing when a change in status of any one of photofinishers 102 occurs, photo lab system 104 may be configured to conduct additional tasks, such as, for example, receive print orders from a print product ordering server 118. Therefore, photo lab system 104 may be in communication with print product ordering server 118 to receive print orders to be fulfilled by one or more of photofinishers 102 and communicating the print orders to the appropriate photofinisher 102.

Photo lab system 104 may also be in communication with at least one remote computing device 106 through network 112. Photo lab system 104 includes a notification module that is configured for sending a notification to at least one of the remote computing devices 106 including information related to the change in status of one or more of photofinishers 102. The remote computing devices 106 described herein may be any type of smart phone, tablet, TELXON laser/optical scan device, laptop, desktop computer, or other mobile device that is capable of receiving the notification from photo lab system 104, or directly from the photofinisher 102 that had a change in status, through network 112. The term “remote,” as used to describe each of the remote computing devices 106, is meant to indicate that each of the remote computing devices 106 are not integrally formed with, or directly attached to, the photofinishers 102 or photo lab system 104. However, it should be understood that remote computing devices 106 may be physically located either within or outside of fulfillment center 108, or located within or outside the store that fulfillment center 108 is located within.

The notification that is sent to the one or more remote computing devices 106 may be in the form of an electronic mail, SMS text message, MMS text message, push notification, application communication, and/or automated voice message. Therefore, the notification may be displayed on the at least one remote computing device 106 that received the notification, or listened to using a speaker of respective device 106. The information related to the change in status of the photofinisher 102 included in the notification may include at least one of identifying information of the photofinisher 102 with the change in status, information describing the changed status of the photofinisher 102, an urgency level, or at least one of text, audio, or video including instructional information to assist with resolving the issue that caused the change in status of the photofinisher 102 to place or maintain the photofinisher 102 in an operational state. By sending the notification to one or more of remote computing devices 106 including the aforementioned information, the issue that caused the change in status of photofinisher 102 can be made known to the appropriate individuals in possession of the remote computing devices 106 so that the issue can be resolved in an efficient manner without having to rely on continuous, direct manual monitoring of photo lab system 104.

In another aspect of the invention, the notification module may be located in a notification server 120 that is remote from fulfillment center 108, but still in communication with photo lab system 104, photofinishers 102, and remote computing devices 106 through network 112. Notification server 120 may be used to centralize the dispatch of notifications sent to remote computing devices 106 when there are a plurality of fulfillment centers that are to be monitored using the system and method of the present invention. It is also contemplated that each of the photofinishers 102 include the photofinisher status module and the notification module, thereby reducing the need to use photo lab system 104 for these purposes.

In yet another aspect of the present invention, system 100 may further include a notification management application program, such as a mobile application program, that may be executed and utilized on a remote computing device, which may be one of remote computing devices 106. Notification management application program may be configured for providing controls for managing and tracking the notifications that are sent to one or more of remote computing devices 106. In particular, the notification management application program may be configured for receiving all of the notifications on the change in status of the photofinishers 102 from photo lab system 102, notification server 120, or directly from photofinisher 102, and allowing the received notifications to be selectively directed to one or more remote computing device 106. Therefore, the individual using the notification management application program has the ability to assign the responsibility of resolving the issue that caused the change in status to the individuals that are in possession of certain remote computing devices 106 by directing the notification to the appropriate remote computing devices 106. Notification management application program may also provide for additional management controls and features, such as, but not limited to, tracking the status of the notifications sent to remote computing devices 106 (e.g., acceptance or dismissal of notifications, as described below), viewing real-time feedback of the status of photofinishers 102 either directly or through photo lab system 104, providing historical data on past changes in status for each photofinisher 102, tracking the amount of time it takes to resolve an issue that caused the change in status for a particular photofinisher 102, etc.

The system 100 of the present invention may also provide each of the remote computing devices 106 with the ability to send a confirmation receipt to the appropriate system component 102, 104, 120 indicating that the notification was received by the respective remote computing device 106 and that the issue will be resolved by the individual sending the confirmation receipt. The confirmation receipt can be sent by the remote computing device 106 in the same form of communication that the notification was sent. For example, if remote computing device 106a receives a notification including information related to a status change of photofinisher 102b from photo lab system 104 by SMS text, then remote computing device 106a will have the ability to send a confirmation receipt to photo lab system 104 by SMS text. Further, in this example, if no confirmation receipt is received by photo lab system 104 within a predetermined period of time, then the notification may be resent to the same remote computing device 106a and/or to one or more other remote computing devices 106b, 106x.

The system 100 of the present invention may also provide each of the remote computing devices 106 with the ability to dismiss the notification that was received indicating that the issue will not be resolved by the individual that received the notification, wherein a dismiss notification is sent to the appropriate system component 102, 104, 120. Using the example above, if remote computing device 106a receives a notification and the user of that device 106a sends a dismiss notification to photo lab system 104, photo lab system 104 is configured to send the notification of the change in status to one or more other remote computing devices 106b, 106x. The system 100 also provides for automatic dismissal of a notification that was sent to a remote computing device 106 if a confirmation receipt is not received from that remote computing device 1060 within a predetermined period of time, for example, 1 day. Therefore, the above-referenced sequential status notification system is contemplated herein, wherein not all remote computing devices 106 are notified at the same time, but is instead done sequentially in smaller groups of one or more remote computing devices.

Another aspect of the present invention may include classifying the detected or recognized change in status of photofinishers 102 depending on the nature of the issue that caused the change in status, and selectively sending the notification of the urgency level to certain remote computing devices 106 depending on the ability of the individuals in possession of the remote computing devices 106 to resolve the issue that caused the change in status. For example, there could be three classification levels—blue level, yellow level, and red level. A notification at the blue level could be described as an informational message that does not necessarily require any action to keep photofinisher 102 operational, but conveys an impending issue that can be handled with relative ease. An example of a blue level issue could be photofinisher 102 with a low level of ink. A notification at the yellow level could be described as a task that needs to be performed in order for photofinisher 102 to keep running in an efficient manner. An example of a yellow level issue could be that the next print order will require a different size paper in order to be fulfilled. Thus, if the different size paper is not provided, the print order may be put on hold in the print queue and the fulfillment time may be extended. A notification at the red level could be described as a task that needs to be performed to keep photofinisher 102 printing and maintain customer expectations on print order completion time. An example of a red level issue could be that the photofinisher is out of ink, has a paper jam, mechanical or electrical malfunction, needs a part replaced, such as a paper cutter, or a print order has passed its completion deadline. These red level issues can be generally described as output errors or system level errors.

For example, using the above blue, yellow and red classification levels described above, if the status of photofinisher 102a was changed due to an issue that was classified in the red level, the system 100 may operate to first send a notification to a first group of one or more remote computing devices 106a, 106b that are in the possession of individuals that are known to have the technical expertise or skills necessary to resolve the red level issue in an efficient manner. As was described above, if a confirmation receipt is not received from any of the remote computing devices in the first group of remote computing devices 106a, 106b within a predetermined period of time, the system 100 of the present invention is configured to send the notification to a second group of one or more remote computing devices 106x in an attempt to resolve the red level issue. While three urgency level notifications are described herein, it is understood that any number or identification of urgency levels are contemplated.

In yet another aspect of the invention, system 100 includes the selective notification of one or more remote computing devices 106 depending on the geographic proximity of the one or more remote computing devices 106 to the photofinisher 102 with the change in status. For example, the system component 102, 104, 120 that is responsible for generating the notification may be configured for either determining the geographic proximity of one or more of remote computing devices 106 relative to the photofinisher 102 with the change in status, or is provided with the geographic proximity of one or more of remote computing devices 106 relative to the photofinisher 102 with the change in status. As such, one or more of remote computing devices 106 may be configured with a global positioning system (GPS), or some other known system used for determining the geographic proximity of the remote computing devices 106 relative to the photofinisher 102 with the change in status. Based on the geographic proximity information of remote computing devices 106, it can be determined which of the remote computing devices 106 are best positioned to address the issue that resulted in the change in status. For instance, the notification could be sent to all remote computing devices 106 within a 0.5 mile radius of the photofinisher 102, thereby not sending the notification to those remote computing devices 106 outside that radius. The reason being that remote computing devices 106 located outside that distance would be too far to assist in an efficient time frame, or may indicate that the individuals in possession of the remote computing devices 106 are not currently working. Another scenario would be to send the notification to the remote computing device 106 located in closest proximity to the photofinisher 102 with the change in status, thereby attempting to resolve the issue efficiently and potentially not having to notify multiple individuals at the same time.

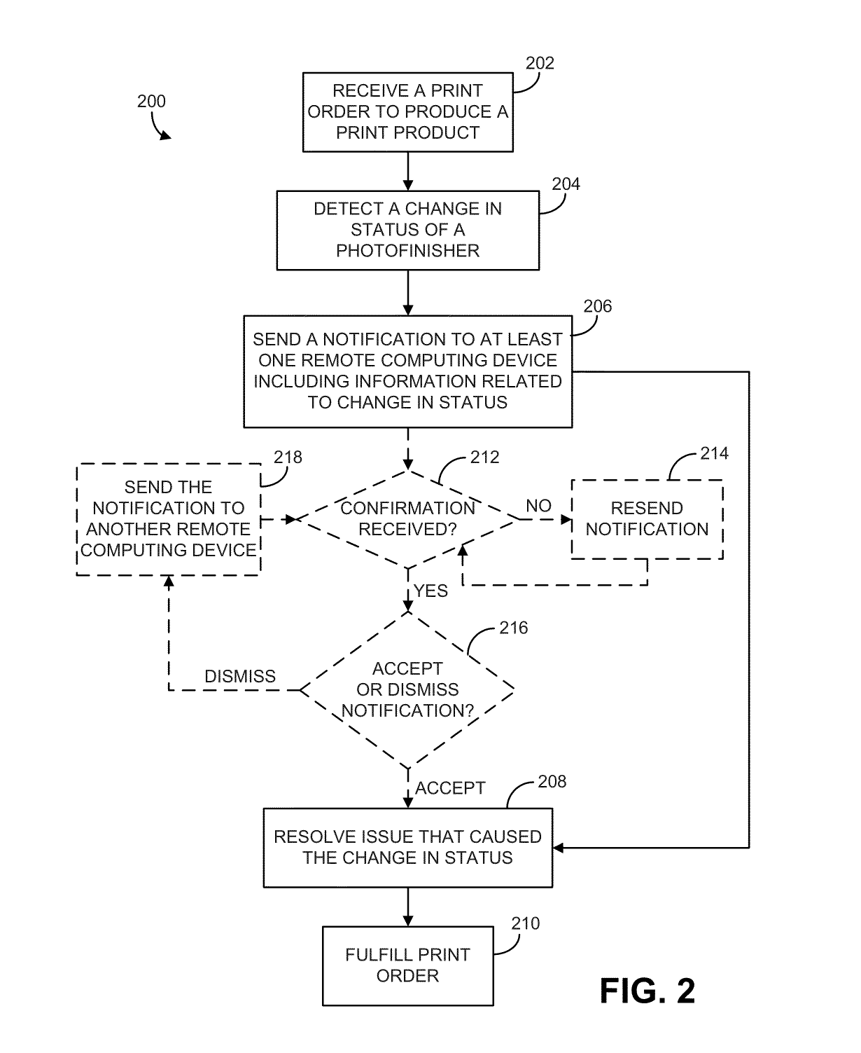

Having described system 100 as provided by the present invention, an exemplary method 200 for providing notification of a change in status of a photofinisher will now be described. As best seen in FIG. 2, method 200 comprises the step 202 of receiving a print order specifying the print product and print characteristics to be produced by one or more of photofinishers 102, wherein the print product incorporates a digital image. The print order may be provided to print product ordering server 118 using, for example, customer computing device 114, kiosk 116, or a customer mobile computing device, such as a smart phone. Once the print order is communicated to print product ordering server 118, the print order is communicated to photo lab system 104 so that the print order can be sent to the appropriate photofinisher 102a, 102b, 102c, 102d having the capability to fulfill the print order. It is also contemplated that the print order be sent directly to the appropriate photofinisher 102a, 102b, 102c, 102d without passing through photo lab system 104. After the print order is received by the appropriate photofinisher, for example, photofinisher 102a, either before beginning production of the print product or during the course of producing the print product, photofinisher 102a may undergo a change in status. The change in status is then detected by either photo lab system 104 or photofinisher 102a using a photofinisher status module at step 204. If the change in status is detected by photofinisher 102a, then photo lab system 104 may be configured to recognize the change in status detected by photofinisher 102a. At step 206, a notification is then sent to at least one of remote computing devices 106, for example, remote computing device 106a, including information related to the change in status. It should be understood that the notification may be sent using a notification module by either photofinisher 102a, photo lab system 104, or notification server 120. Further, the notification may be selectively sent to certain remote computing devices 106 depending on the geographic proximity of the computing devices 106 relative to photofinisher 102a. For instance, the notification may be sent to remote computing device that is the closest to the photofinisher 102a so that the issue causing the notification can be resolved in an efficient manner. In another instance, the notification can be sent to all remote computing devices 106 located within a predetermined distance of the photofinisher 102a.

At step 208, the individual in possession of remote computing device 106a that received the notification, for example, a store employee, may then take the necessary steps to resolve the issue that caused the change in status of photofinisher 102a in an efficient manner. Photofinisher 102a can thereafter fulfill the print order and produce the print product at step 210.

In another aspect, after step 206, method 200 may further include the ability for remote computing device 106a that received the notification to send a confirmation receipt to the system component that sent the notification at step 212. If a confirmation receipt is not received by the system component that sent the notification, preferably within a predetermined time period, such as 1 hour, the method includes having the system component resend the notification to those particular remote computing devices 106 that have not provided confirmation at step 214. The confirmation sent by each of the respective remote computing devices 106 that received a notification may include an indication as to whether or not the individuals in possession of the respective remote computing devices 106 that received the notification will accept or dismiss the notification at step 216. An acceptance indicates that the individual will take the necessary steps to resolve the issue that caused the change in status at step 208. A dismissal of the notification indicates that the individual will not take steps to resolve the issue that caused the change in status. If a notification is affirmatively dismissed, and no other acceptances have been received, then the notification is sent to another one of the at least one remote computing devices 106 at step 218. A passive dismissal may also occur if an acceptance of the notification is not received by the system component that sent the notification after a predetermined period of time, for example, 1 day, in which case the method would proceed to step 318 so that another remote computing device 106 may be notified of the change in status.

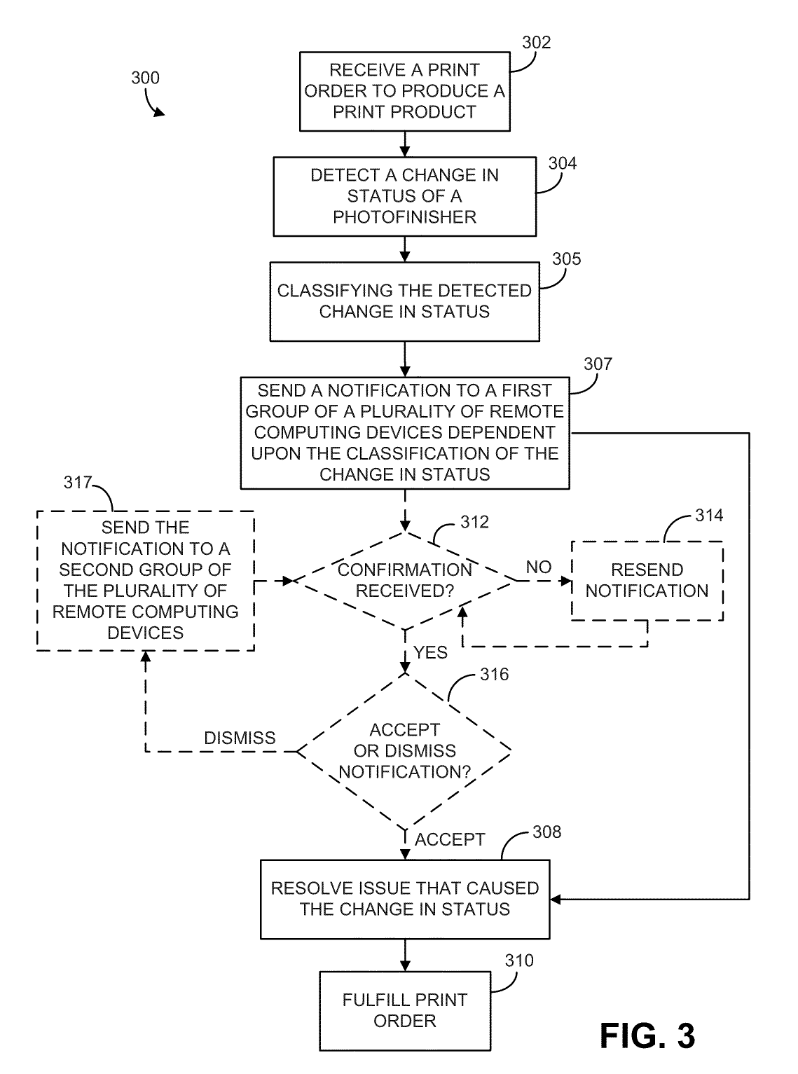

In yet another aspect of the present invention, with reference to FIG. 3, a method 300 may be provided that classifies the issue that caused the change in status of the photofinisher, and selectively sends the notification to a certain group of remote computing devices 106 that are in the possession of an individual that has access to the necessary resources or technical expertise to resolve the issue. Many of the steps set forth in method 300 are the same as those described with respect to method 200, and need not be described in any further detail. The similar steps will be labeled with the same reference numbers as in FIG. 2 except in the 300 series.

In particular, as best seen in FIG. 3, after a change in status of a photofinisher 102a is detected at step 304, the change in status is classified based on the nature of the issue that caused in the change in status at step 305. For example, if the cutting mechanism on photofinisher 102a breaks, which in turn causes photofinisher 102a to stop producing print products, this may be classified a red level occurrence. In this example, the system component responsible for sending notifications uses the notification module to send a notification to a certain first group of remote computing devices 106a, 106a that are in the possession of individuals that have the resources and/or technical expertise to resolve the issue with the cutting mechanism at step 307. The classification of the detected change in status is advantageous in that it directs the resulting notification to the appropriate individuals that can resolve the issue with the photofinisher 102a efficiently. If the notification is eventually dismissed by the first group of remote computing devices 106a, 106b at step 316, then method 300 further includes sending the notification to a second group of remote computing devices 106x at step 317. Although the second group of remote computing devices 106x may not be in the possession of individuals that can resolve the issue as quickly as the individuals in possession of the first group of remote computing devices 106a, 106b, the second group will be made aware of the issue that caused the change in status and take steps to resolve the issue.

By providing the system and method in accordance with the present invention, numerous advantages are realized. For example, any issue that results in a change in status of a photofinisher can be resolved in an efficient manner without having to rely on individuals being in continuous, direct visual proximity to the photofinisher to recognize that an issue has presented itself. In addition, the system and method of the present invention also provides a system for classifying issues that are encountered by a photofinisher, and notifying those individuals that are best suited to resolve the issue in an efficient manner. This aspect reduces the need to inconvenience individuals that may not have the ability to resolve the issue, thereby leaving these individuals with more time to attend to other responsibilities.

Having described the system and method of the present invention and an embodiment thereof, an exemplary computer environment for implementing the described design and execution is presented next.

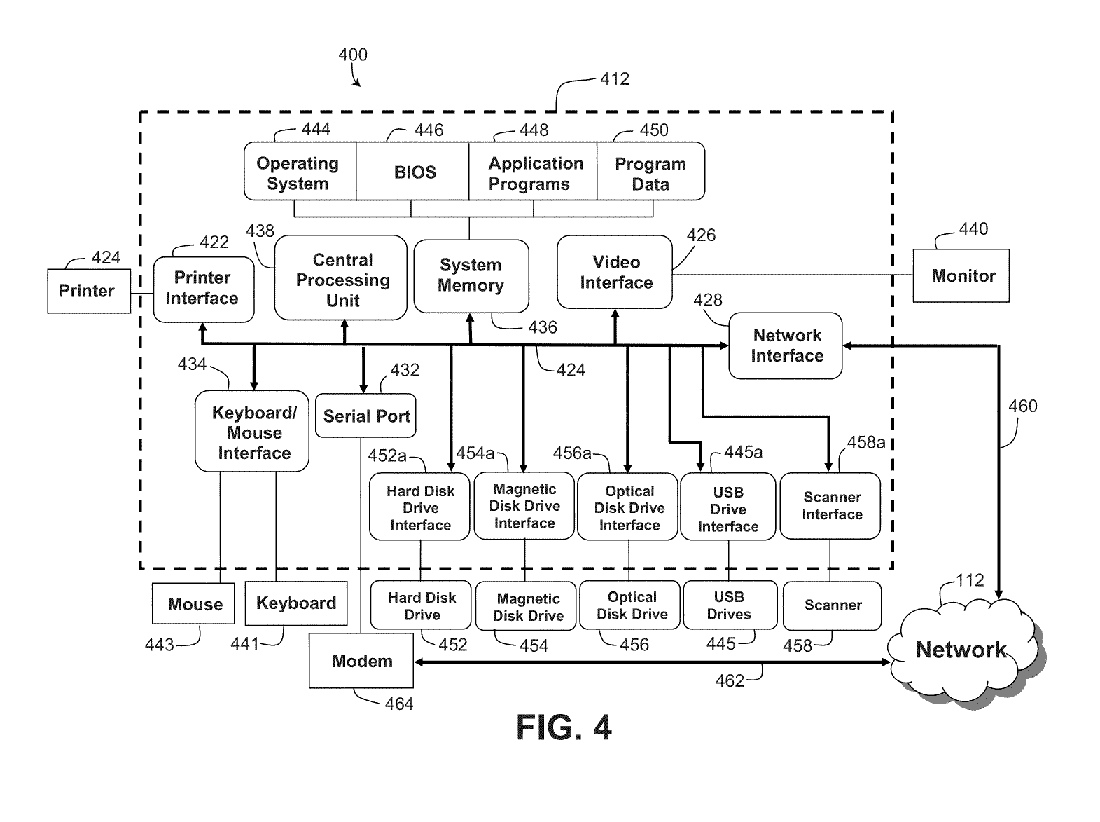

FIG. 4 shows an exemplary computing environment 400 that can be used to implement any of the processing thus far described. Computing environment 400 may include one or more computers 412 (such as photofinishers 102, photo lab system 104, remote computing devices 106, customer computing device 114, kiosk 116, notification server 120, or print product ordering server 118) comprising a system bus 424 that couples a video interface 426, network interface 428, a keyboard/mouse interface 434, a printer interface 422, and a system memory 436 to a Central Processing Unit (CPU) 438. A monitor or display 440 is connected to bus 424 by video interface 426 and provides the user with a graphical user interface to view the status notifications. The printer interface 422, for example, allows for a printer 424 associated with photofinisher 102 to be used to produce the print products specified in the print orders. The graphical user interface allows the user to enter commands and information into computer 412 using a keyboard 441 and a user interface selection device 443, such as a mouse or other pointing device, or using a touch screen system. Keyboard 441 and user interface selection device are connected to bus 424 through keyboard/mouse interface 434. The display 440 and user interface selection device 443 are used in combination to form the graphical user interface which allows the user to implement at least a portion of the present invention. Other peripheral devices may be connected to the computer through universal serial bus (USB) drives 445 to transfer information to and from computer 412. For example, cameras and camcorders may be connected to computer 412 through serial port 432 or USB drives 445 so that data representative of a digital image, or other digital content may be downloaded to system memory 436 or another memory storage device associated with computer 412 such that the images may be subsequently printed by one or more of photofinishers 102.

The system memory 436 is also connected to bus 424 and may include read only memory (ROM), random access memory (RAM), an operating system 444, a basic input/output system (BIOS) 446, application programs 448 and program data 450. The computer 412 may further include a hard disk drive 452 for reading from and writing to a hard disk, a magnetic disk drive 454 for reading from and writing to a removable magnetic disk (e.g., floppy disk), and an optical disk drive 456 for reading from and writing to a removable optical disk (e.g., CD ROM or other optical media). The computer 412 may also include USB drives 445 and other types of drives for reading from and writing to flash memory devices (e.g., compact flash, memory stick/PRO and DUO, SD card, multimedia card, smart media xD card), and a scanner 458 for scanning items such as still image photographs to be downloaded to computer 412. A hard disk drive interface 452a, magnetic disk drive interface 454a, an optical drive interface 456a, a USB drive interface 445a, and a scanner interface 458a operate to connect bus 424 to hard disk drive 452, magnetic disk drive 454, optical disk drive 456, USB drive 445 and scanner 458, respectively. Each of these drive components and their associated computer-readable media may provide computer 412 with non-volatile storage of computer-readable instruction, program modules, data structures, application programs, an operating system, and other data for computer 412. In addition, it will be understood that computer 412 may also utilize other types of computer-readable media in addition to those types set forth herein, such as digital video disks, random access memory, read only memory, other types of flash memory cards, magnetic cassettes, and the like.

Computer 412 may operate in a networked environment using logical connections with system 100. Network interface 428 provides a communication path 460 between bus 424 and network 112, which allows, for example, a notification from the photo lab system 104, notification server 120, or photofinisher 102 to be communicated through network 112 to remote computing devices 106. Notifications, for example, may also be communicated from bus 424 through a communication path 462 to network 112 using serial port 432 and a modem 464. Using a modem connection between the computer 412 and a photofinisher is commonly used in conjunction with a wide area network (WAN). It will be appreciated that the network connections shown herein are merely exemplary, and it is within the scope of the present invention to use other types of network connections between computer 412 and photofinishers including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirements.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method for providing notification of a change in status of a photofinisher, the method comprising:
providing a photofinisher configured for producing a print product incorporating a digital image, the print product being specified in a print order;
receiving the print order to be produced by the photofinisher;
detecting a change in status of the photofinisher; and
sending a notification to at least one remote computing device, wherein the notification sent to the at least one remote computing device includes information related to the change in status of the photofinisher.

2. A method in accordance with claim 1, wherein situations that result in the change in status of the photofinisher includes when the photofinisher needs to be loaded with additional paper, paper in the photofinisher needs to be changed to a different size, a mechanical or electrical malfunction has occurred with the photofinisher, ink in the photofinisher is below a predetermined threshold, or the photofinisher is jammed with paper.

3. A method in accordance with claim 1, wherein the remote computing device is selected from the group consisting of a mobile computing device, a smart phone, tablet, laser/optical scan device, laptop, and desktop computer.

4. A method in accordance with claim 1, wherein the step of detecting the change in status of the photofinisher occurs before the photofinisher begins producing the print product.

5. A method in accordance with claim 1, wherein the step of detecting the change in status of the photofinisher occurs while the photofinisher is producing the print product.

6. A method in accordance with claim 1, further comprising classifying the detected change in status of the photofinisher depending on the nature of the issue that caused in the change in status.

7. A method in accordance with claim 6, wherein the at least one remote computing device is a plurality of remote computing devices, further comprising sending the notification to one or more certain remote computing devices from the plurality of remote computing devices, wherein the one or more certain remote computing devices are determined based upon the classification of the detected change in status of the photofinisher.

8. A method in accordance with claim 1, wherein the at least one remote computing device is a plurality of remote computing devices, wherein the notification of the change in status is sent to the one remote computing device of the plurality of remote computing devices that is in the closest geographic proximity to the photofinisher.

9. A method in accordance with claim 1, wherein the at least one remote computing device is a plurality of remote computing devices, wherein the notification of the change in status is not sent to the one or more remote computing devices that are located outside a predetermined geographic area relative to the photofinisher.

10. A method in accordance with claim 1, wherein the information related to the change in status of the photofinisher includes at least one of: identifying information of the photofinisher with the change in status, information describing the changed status of the photofinisher, an urgency level, or at least one of text, audio, or video to assist with placing the photofinisher in an operational state.

11. A method in accordance with claim 1, wherein the notification is sent to the at least one remote computing device in the form of electronic mail, SMS text message, MMS text message, push notification, application communication, or automated voice message.

12. A method in accordance with claim 1, further comprising the step of receiving confirmation from the at least one remote computing device indicating that the notification was received by the at least one remote computing device.

13. A method in accordance with claim 1, further comprising resending the notification of the change in status to the at least one remote computing device if a confirmation receipt for the notification is not received within a predetermined time period.

14. A method in accordance with claim 1, wherein the at least one remote computing device is a plurality of remote computing devices, wherein the notification is sent to a first group of the plurality of remote computing devices, wherein if a confirmation receipt for the notification is not received within a predetermined time period from the first group then the method further comprises sending the notification to a second group of the plurality of remote computing devices.

15. A method in accordance with claim 1, further comprising the step of allowing for the notification on the at least one remote computing device to be dismissed.

16. A method in accordance with claim 15, wherein the dismissal of the notification occurs automatically after a predetermined period of time.

17. A method in accordance with claim 15, wherein the at least one remote computing device is a plurality of remote computing devices, wherein after the dismissal of the notification, the notification is sent to another one of the at least one remote computing devices.

18. A method in accordance with claim 1, wherein the print product includes at least one of a photographic print, calendar, poster, photo book, mug, t-shirt, gift card, or canvas prints.

19. A photofinisher status notification system comprising:
a photofinisher configured for receiving a print order specifying a print product to be fulfilled, wherein the print product incorporates a digital image, wherein the photofinisher is configured for producing the print product;
a photo lab system in communication with the photofinisher, wherein the photo lab system is configured for recognizing a change in status of the photofinisher; and
at least one remote computing device in communication with the photo lab system, wherein the photo lab system is configured for sending a notification to the at least one remote computing device including information related to the change in status of the photofinisher.

20. A photofinisher status notification system in accordance with claim 19, further comprising a notification server, wherein the notification server is in communication with the photo lab system, and wherein the notification server is configured for sending the notification to the at least one remote computing device on behalf of the photo lab system.

21. A photofinisher status notification system in accordance with claim 19, wherein the at least one remote computing device is in communication with the photo lab system over a network.

22. A photofinisher status notification system in accordance with claim 19, further comprising a print product ordering server configured for receiving the print order and sending the print order to the photofinisher.

23. A photofinisher status notification system in accordance with claim 22, wherein the print product ordering server is configured for hosting a print product ordering website.

24. A photofinisher status notification system in accordance with claim 19, further comprising a kiosk configured for receiving the print order and sending the print order to the photofinisher.

25. A photofinisher status notification system in accordance with claim 19, wherein situations that result in the change in status of the photofinisher includes when the photofinisher needs to be loaded with additional paper, paper in the photofinisher needs to be changed to a different size, a mechanical or electrical malfunction has occurred with the at least one photofinisher, ink in the photofinisher is below a predetermined threshold, or the photofinisher is jammed with paper.

26. A photofinisher status notification system in accordance with claim 19, wherein the remote computing device is selected from the group consisting of a mobile computing device, a smart phone, tablet, laser/optical scan device, laptop, and desktop computer.

27. A photofinisher status notification system in accordance with claim 19, wherein the information related to the change in status of the photofinisher includes at least one of: identifying information of the photofinisher with the change in status, information describing the changed status of the photofinisher, an urgency level, or at least one of text, audio, or video to assist with placing the photofinisher in an operational state.
